(19) United States
(12) Patent Application Publication
(10) Pub. No.: US 2026/0140663 A1
(43) Pub. Date: May 21, 2026

(54) STORAGE DEVICE CONTROLLING INPUT ORDER OF COMMANDS AND METHOD FOR OPERATING THE STORAGE DEVICE

(71) Applicant: SK hynix Inc., Icheon-si (KR)

(72) Inventors: Seung Gu JI, Icheon-si (KR); Hye Rim Hyun, Icheon-si (KR)

(21) Appl. No.: 19/174,776

(22) Filed: Apr. 9, 2025

(30) Foreign Application Priority Data
Nov. 19, 2024 (KR) 10-2024-0164654

(51) Int. Cl. G06F 3/06

(52) U.S. Cl. CPC G06F 3/0659; G06F 3/0611; G06F 3/0673

(57) ABSTRACT

A storage device includes a memory and a controller. The memory includes a first terminal configured to receive commands, a second terminal configured to receive or output data, and a plurality of memory units configured to store data. The controller transmits a read command for target data including a plurality of sub data units to the first terminal, transmits, to the first terminal, a start command instructing initiation of an operation to output one or more of the plurality of sub data units to the second terminal, and transmits, to the first terminal, a first data output command instructing output of a first sub data unit among the plurality of sub data units to the second terminal.

### CROSS-REFERENCES TO RELATED APPLICATION

The present application claims priority under 35 U.S.C. 119(a) to Korean patent application number 10-2024-0164654 filed on Nov. 19, 2024, which is incorporated herein by reference in its entirety.

### BACKGROUND

### 1. Technical Field

Embodiments of the present disclosure relate to a storage device controlling an input order of commands and a method for operating the same.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

Conventional storage devices use a shared path for command input and data input/output. As a result, the controller cannot input commands to the memory while data is being output from the memory.

### SUMMARY

Embodiments of the present disclosure provide a storage device

and a method for operating the same, designed to enhance the performance of a read operation by minimizing the overhead caused by additional commands. This is achieved by separating a path used for command input from a path used for data input/output.

In one aspect, embodiments of the present disclosure may provide a storage device comprising a memory including a first terminal configured to receive commands, a second terminal configured to receive or output data, and a plurality of memory units configured to store data and a controller configured to transmit a read command for target data including a plurality of sub data units to the first terminal, transmit, to the first terminal, a start command instructing initiation of an operation to output one or more of the plurality of sub data units to the second terminal, and transmit, to the first terminal, a first data output command instructing output of a first sub data unit among the plurality of sub data units to the second terminal.

In another aspect, embodiments of the present disclosure may provide a method for operating a storage device comprising a memory with a first terminal for receiving commands, a second terminal for receiving or outputting data, and a plurality of memory units for storing data, the method comprising: transmitting a read command for target data including a plurality of sub data units to the first terminal and transmitting, to the first terminal, a start command instructing initiation of an operation to output one or more of the plurality of sub data units to the second terminal, and transmitting, to the first terminal, a first data output command instructing output of a first sub data unit among the plurality of sub data units to the second terminal.

According to the embodiments of the present disclosure, it is possible to enhance the read operation performance by minimizing the overhead caused by additional commands during a read operation, achieved by separating the path used for command input from the path used for data input/output.

### BRIEF DESCRIPTION OF THE DRAWINGS

FIG. 1 illustrates a storage device according to an embodiment of the present disclosure.

FIG. 2 illustrates a memory of FIG. 1.

FIG. 3 illustrates a storage device according to an embodiment of the present disclosure;

FIG. 4 illustrates an operation in which a storage device processes a read command according to an embodiment of the present disclosure;

FIG. 5 illustrates an operation in which a storage device compares first address information and second address information according to an embodiment of the present disclosure;

FIG. 6 illustrates first address information and second address information according to an embodiment of the present disclosure;

FIG. 7 illustrates first address information and second address information according to another embodiment of the present disclosure;

FIGS. 8 and 9 illustrate an operation in which a storage device reads a first sub-data unit and a second sub-data unit according to an embodiment of the present disclosure;

FIG. 10 illustrates an operation in which a storage device reads a first sub-data unit and a second sub-data unit according to another embodiment of the present disclosure; and

FIG. 11 illustrates a method for operating a storage device according to an embodiment of the present disclosure.

### DETAIL DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present invention are described below in more detail with reference to the accompanying drawings. However, the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

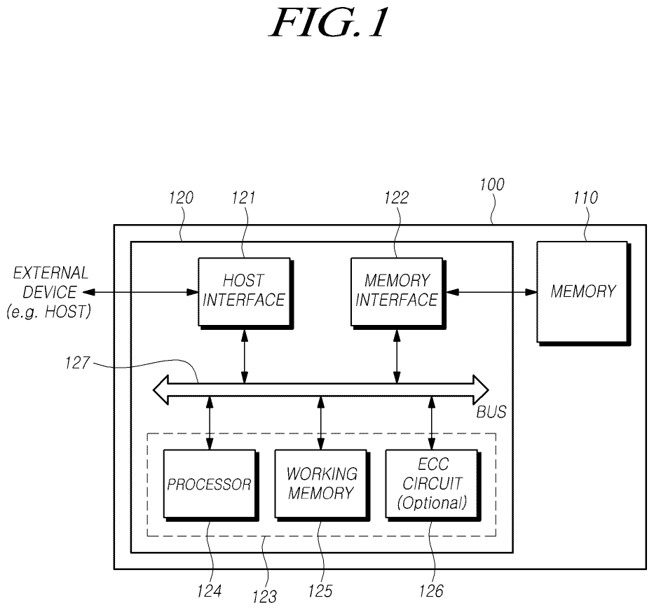

FIG. 1 illustrates a storage device 100 according to an embodiment of the present disclosure.

Referring to FIG. 1, the storage device 100 may include a memory 110 that stores data and a controller 120 that controls the memory 110.

The memory 110 includes a plurality of memory blocks, and operates under the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and so forth.

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request from the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 under the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (or drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110, a host interface layer (HIL), which serves to analyze a command requested to the storage device 100 as a storage device from the host and transfer the command to the flash translation layer, and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the

memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or has failed. On the other hand, when a bit error rate is lower than the reference value, the error detection and correction circuit 126 may determine that a corresponding sector is correctable or has passed.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the

components 121, 122, 124, 125, and 126 of the controller 120. The bus 127 may include, for example, a control bus for transferring various control signals, commands and the like, a data bus for transferring various data, and so forth.

Some components among the above-described components 121, 122, 124, 125, and 126 of the controller 120 may be omitted, or some components among the above-described components 121, 122, 124, 125, and 126 of the controller 120 may be integrated into one component. In addition to the above-described components 121, 122, 124, 125, and 126 of the controller 120, one or more other components may be added.

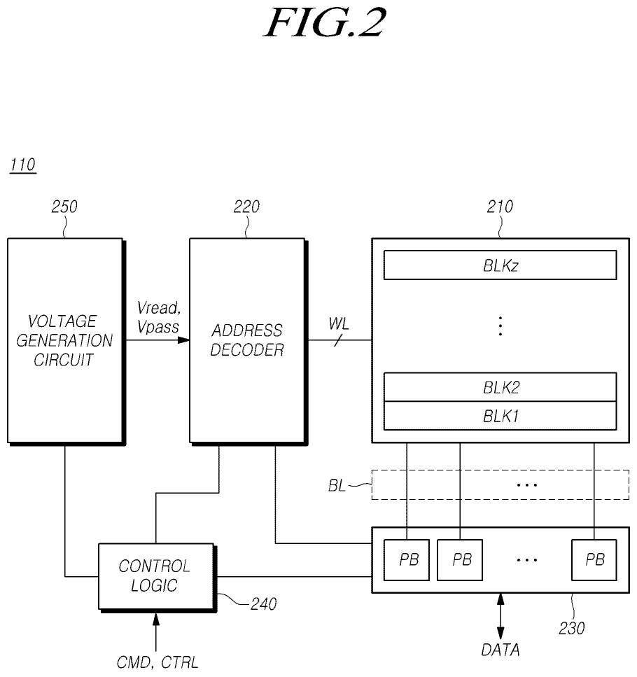

Hereinbelow, the memory 110 will be described in further detail with reference to FIG. 2.

FIG. 2 illustrates the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read

and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals output from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (or write operation) of the memory block described above may be performed by the unit of a page, and an erase operation may be performed by the unit of a memory block.

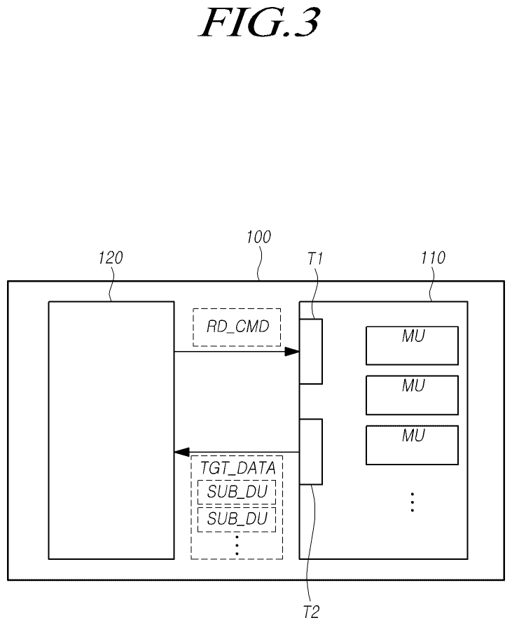

FIG. 3 illustrates a storage device 100 according to an embodiment of the present disclosure.

Referring to FIG. 3, the storage device 100 may include a memory 110 and a controller 120.

The memory 110 may include a first terminal T1 for receiving a command, a second terminal T2 for receiving or outputting data, and a plurality of memory units MU capable of storing data.

Each of the first terminal T1 and the second terminal T2 may include one or more pins. For example, the first terminal T1 may include one or two pins, and the second terminal T2 may include a plurality of pins.

An electrical circuit used for command input may be disposed between the first terminal T1 and the controller 120. An electrical circuit used for data input/output may be disposed between the second terminal T2 and the controller 120.

The memory unit may be implemented in various forms.

For example, each memory unit may be a die or a plane included in the memory 110. The plurality of memory units MU may be accessed in parallel. When a read operation or a write operation is performed on one memory unit, an operation on another memory unit may be performed simultaneously.

As another example, each memory unit may include one or more memory blocks or one or more pages included in the memory 110.

Since the first terminal T1 receiving a command and the second terminal T2 receiving or outputting data are separated, the memory 110 may perform a command input operation and a data input/output operation in parallel. In other words, the memory 110 may receive a subsequent command through the first terminal T1 while data associated with a previous command is being output through the second terminal T2. Therefore, since the memory 110 does not need to wait for the completion of data output before receiving the subsequent command, subsequent operations may be performed more efficiently.

The controller 120 may transmit a read command RD_CMD for target data TGT_DATA, which includes a plurality of sub-data units SUB_DU, to the memory 110 through the first terminal T1.

The read command RD_CMD may instruct the loading of the target data TGT_DATA, stored across the plurality of memory units MU, into a buffer (not shown) included in the memory 110.

Subsequently, the memory 110 may output the target data TGT_DATA through the second terminal T2.

In this case, the memory 110 may output the plurality of sub-data units SUB_DU included in the target data TGT_DATA one at a time, based on a data output command received from the controller 120. In other words, instead of immediately outputting the plurality of sub-data units SUB_DU included in the target data TGT_DATA, the memory 110 may output only a sub-data unit corresponding to a specific data output command received from the controller 120.

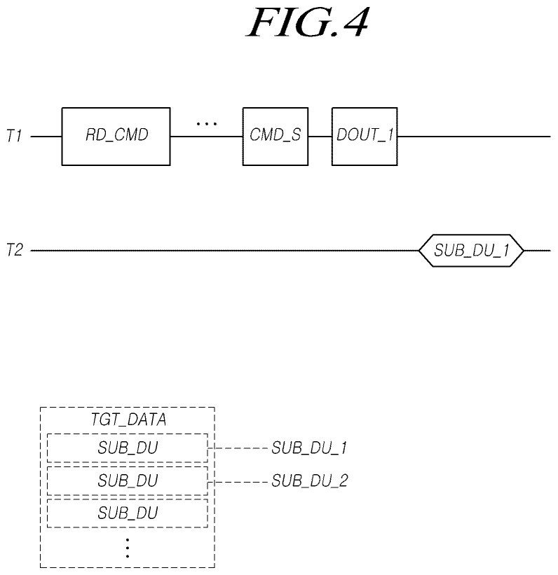

FIG. 4 illustrates an operation in which a storage device 100 processes a read command RD_CMD according to an embodiment of the disclosure. The storage device 100 of FIG. 4 may correspond to the storage device 100 shown in FIG. 3.

Referring to FIG. 4, the controller 120 of the storage device 100 may transmit a read command RD_CMD for target data TGT_DATA to the first terminal T1 of the memory 110.

When the controller 120 transmits the read command RD_CMD to the first terminal T1, a clock signal indicating the input to the first terminal T1 may be separately transmitted to the memory 110.

In response to the read command RD_CMD, the memory 110 may load the target data TGT_DATA into a buffer (not shown) within the memory 110. During the time required to load the target data TGT_DATA, the memory 110 may enter a busy state.

Thereafter, the controller 120 may transmit a start command CMD_S to the first terminal T1. The start command CMD_S may instruct the initiation of an operation to output one or more of the plurality of sub-data units SUB_DU to the second terminal T2. In embodiments of the present disclosure, the start command CMD_S needs to be transmitted to the memory 110 before data is output to the second terminal T2.

In this case, the start command CMD_S may instruct the activation of one or more of the plurality of memory units MU included in the memory 110. Among the plurality of sub-data units SUB_DU, only the sub-data unit stored in the memory unit activated by the start command CMD_S may be output to the second terminal T2.

Subsequently, the controller 120 may transmit a first data output command DOUT_1 to the first terminal T1. The first data output command DOUT_1 instructs the output of the first sub-data unit SUB_DU_1 among the plurality of sub-data units SUB_DU to the second terminal T2. The first sub-data unit SUB_DU_1 is stored in the memory unit activated by the start command CMD_S.

In embodiments of the present disclosure, the memory 110 may process the first data output command DOUT_1 only upon receiving the start command CMD_S. In other words, if the start command CMD_S is

not received, the memory 110 may not process the first data output command DOUT_1, even if the first data output command DOUT_1 is received.

In response to the first data output command DOUT_1, the memory 110 may output the first sub-data unit SUB_DU_1 to the second terminal T2.

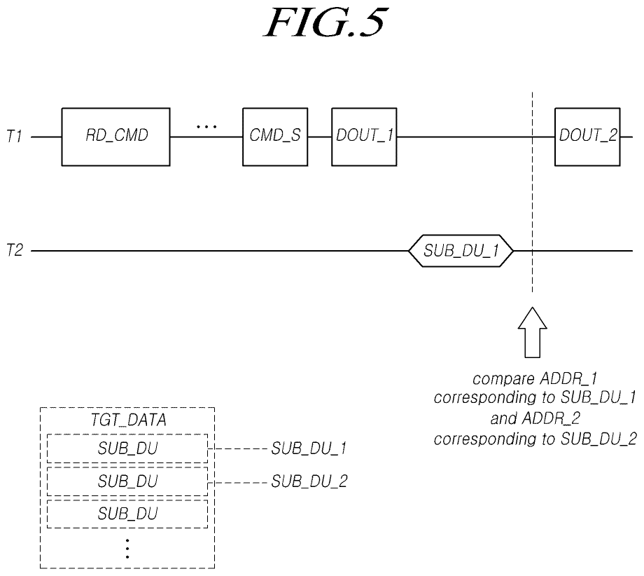

FIG. 5 illustrates an operation in which a storage device 100 compares first address information ADDR_1 and second address information ADDR_2 according to an embodiment of the disclosure. The storage device 100 of FIG. 5 may correspond to the storage device 100 shown in FIG. 3.

Referring to FIG. 5, similar to FIG. 4, the controller 120 may transmit a read command RD_CMD for target data TGT_DATA to the first terminal T1 of the memory 110. In response to the read command RD_CMD, the memory 110 may load the target data TGT_DATA into a buffer (not shown) within the memory 110.

Subsequently, the controller 120 may transmit a start command CMD_S to the first terminal T1.

Subsequently, the controller 120 may transmit a first data output command DOUT_1 to the first terminal T1. In response to the first data output command DOUT_1, the memory 110 may output a first sub-data unit SUB_DU_1 among a plurality of sub-data units SUB_DU to the second terminal T2.

Subsequently, the controller 120 may transmit a second data

output command DOUT_2 to the first terminal T1. The second data output command DOUT_2 instructs the output of a second sub-data unit SUB_DU_2 among the plurality of sub-data units SUB_DU to the second terminal T2.

The second sub-data unit SUB_DU_2 is different from the first sub-data unit SUB_DU_1 and may be stored either in the same memory unit as the first sub data unit SUB_DU_1 or in a different memory unit.

In embodiments of the present disclosure, before transmitting the second data output command DOUT_2 to the first terminal T1, the controller 120 may compare the first address information ADDR_1 corresponding to the first sub-data unit SUB_DU_1 with the second address information ADDR_2 corresponding to the second sub-data unit SUB_DU_2.

In this case, the first address information ADDR_1 may indicate an address of a memory unit storing the first sub-data unit SUB_DU_1 among the plurality of memory units MU. The second address information ADDR_2 may indicate an address of a memory unit storing the second sub-data unit SUB_DU_2 among the plurality of memory units MU.

In other words, comparing the first address information ADDR_1 and the second address information ADDR_2 involves determining whether the previously output first sub-data unit SUB_DU_1 and the second sub-data unit SUB_DU_2, which is to be output in the future, are stored in the same memory unit.

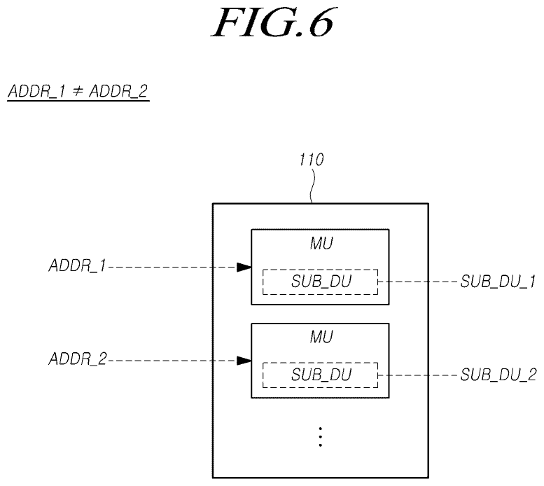

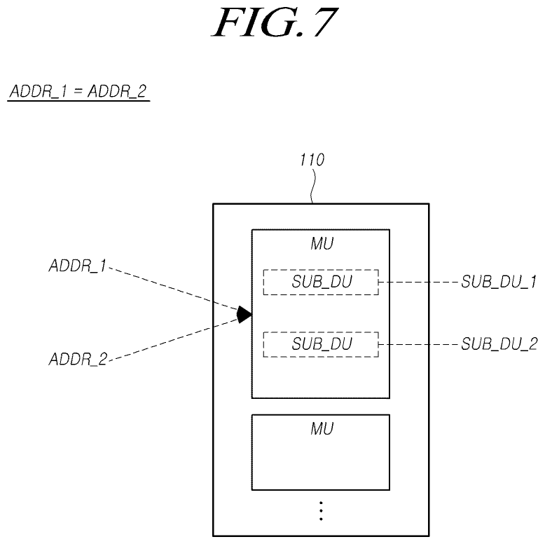

The first address information ADDR_1 and the second address information ADDR_2 may be either identical or different. Hereinafter, this is described in detail with reference to FIGS. 6 and 7.

FIG. 6 illustrates first address information ADDR_1 and second address information ADDR_2 according to an embodiment of the present disclosure.

In FIG. 6, the first address information ADDR_1 indicates an address of a memory unit storing a first sub-data unit SUB_DU_1 and the second address information ADDR_2 indicates an address of a memory unit storing a second sub-data unit SUB_DU_2.

In this case, the first sub-data unit SUB_DU_1 and the second sub-data unit SUB_DU_2 are stored in different memory units. Therefore, values of the first address information ADDR_1 and the second address information ADDR_2 are different from each other.

FIG. 7 illustrates first address information ADDR_1 and second address information ADDR_2 according to another embodiment of the present disclosure.

In FIG. 7, the first address information ADDR_1 indicates an address of a memory unit storing a first sub-data unit SUB_DU_1 and the second address information ADDR_2 indicates an address of a memory unit storing a second sub-data unit SUB_DU_2.

In this case, the first sub-data unit SUB_DU_1 and the second sub-data unit SUB_DU_2 are stored in the same memory unit. Therefore, values of the first address information ADDR_1 and the second address information ADDR_2 are the same.

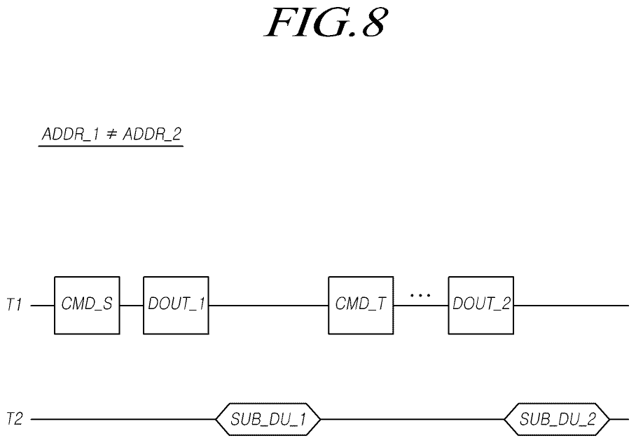

In embodiments of the present disclosure, an operation in which the storage device 100 reads the first sub-data unit SUB_DU_1 and the second sub-data unit SUB_DU_2 may vary depending on whether the first address information ADDR_1 matches the second address information ADDR_2. Hereinafter, it is described in detail with reference to FIGS. 8 to 10.

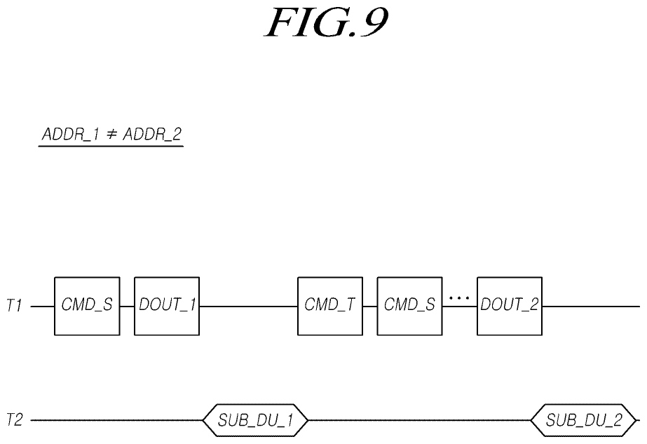

FIGS. 8 and 9 illustrate an operation in which a storage device 100 reads a first sub-data unit SUB_DU_1 and a second sub-data unit SUB_DU_2 according to an embodiment of the present disclosure. The storage device 100 of FIGS. 8 and 9 may correspond to the storage device 100 shown in FIG. 3.

Referring to FIG. 8, when the first address information ADDR_1 is different from the second address information ADDR_2, the controller 120 of the storage device 100 may transmit a termination command CMD_T to the first terminal T1 before transmitting the second data output command DOUT_2.

The termination command CMD_T instructs the termination of the operation of outputting one or more of the plurality of sub-data units SUB_DU to the second terminal T2. In this case, the sub-data unit whose output is terminated by the termination command CMD_T may be the same sub-data unit whose output is initiated by the start command CMD_S.

When the start command CMD_S instructs the activation of one or more of the plurality of memory units MU included in the memory 110, the termination command CMD_T may instructs the deactivation of the memory unit activated by the start command CMD_S.

In this case, a data output operation for the memory unit deactivated by the termination command CMD_T may be performed after receiving the start command CMD_S, which instructs the corresponding memory unit to be activated again.

Meanwhile, referring to FIG. 9, the controller 120 may additionally transmit the start command CMD_S to the first terminal T1 after transmitting the termination command CMD_T to the first terminal T1 and before transmitting the second data output command DOUT_2 to the first terminal T1.

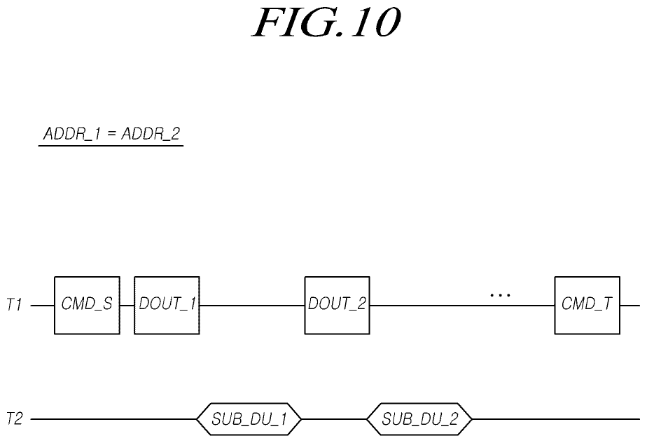

FIG. 10 illustrates an operation in which a storage device 100 reads a first sub-data unit SUB_DU_1 and a second sub-data unit SUB_DU_2 according to another embodiment of the disclosure. The storage device 100 of FIG. 10 may correspond to the storage device 100 shown in FIG. 3.

Referring to FIG. 10, when the first address information ADDR_1 is the same as the second address information ADDR_2, the controller 120 of the storage device 100 may transmit the second data output command DOUT_2 to the first terminal T1 before transmitting the termination command CMD_T.

Compared to the process described in connection with FIGS. 8 and 9, the controller 120 does not need to transmit the termination command CMD_T and the start command CMD_S to the memory 110 again before transmitting the second data output command DOUT_2. Therefore, it is possible to enhance the performance of the read operation by minimizing overheads caused by the termination command CMD_T and the start command CMD_S during the read operation.

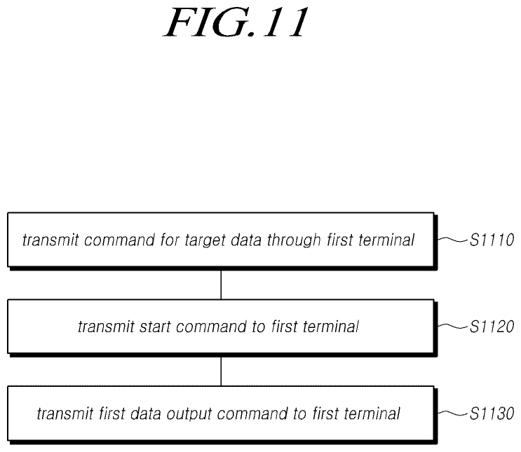

FIG. 11 illustrates a method for operating a storage device 100 according to an embodiment of the present disclosure. The storage device 100 of FIG. 11 may correspond to the storage device 100 shown in FIG. 3.

Referring to FIG. 11, a method may include, for the memory 110 including the first terminal T1 for receiving a command, the second terminal T2 for receiving or outputting data, and the plurality of memory units MU capable of storing data, transmitting (S1110) a read command RD_CMD for target data TGT_DATA, which includes a plurality of sub-data units SUB_DU, to the first terminal T1.

The method may include transmitting (S1120), to the first terminal T1, a start command CMD_S instructing the initiation of an operation to output one or more of the plurality of sub-data units SUB_DU to the second terminal T2.

The method may include transmitting (S1130), to the first terminal T1, a first data output command DOUT_1 instructing the output of a first sub-data unit SUB_DU_1, among the plurality of sub-data units SUB_DU, through the second terminal T2.

For example, the method may further include comparing first address information ADDR_1 corresponding to the first sub-data unit SUB_DU_1 with second address information ADDR_2 corresponding to a second sub-data unit SUB_DU_2 before transmitting, to the first terminal T1, a second data output command DOUT_2 instructing the output of the second sub-data unit SUB_DU_2 among the plurality of sub-data units SUB_DU through the second terminal T2. In this case, the first address information ADDR_1 may indicate an address of a memory unit storing the first sub-data unit SUB_DU_1 among the plurality of memory units MU, and the second address information ADDR_2 may indicate an address of a memory unit storing the second sub-data unit SUB_DU_2 among the plurality of memory units MU.

For example, the method may include transmitting, to the first terminal T1, a termination command CMD_T instructing the termination of the operation of outputting one or more of the plurality of sub-data units SUB_DU through the second terminal T2 before transmitting the second data output command DOUT_2 when the first address information ADDR_1 differs from the second address information ADDR_2 and transmitting the second data output command DOUT_2, before transmitting the termination command CMD_T, to the first terminal T1 when the first address information ADDR_1 is the same as the second address information ADDR_2.

In this case, the method may further include transmitting the start command CMD_S to the first terminal T1 again before transmitting the second data output command DOUT_2 to the first terminal T1, if the termination command CMD_T is transmitted to the first terminal T1 prior to the second data output command DOUT_2.

Meanwhile, the start command CMD_S may instruct the activation of one or more of the plurality of memory units MU. Conversely, the termination command CMD_T may instruct the deactivation of the memory unit previously activated by the start command CMD_S. The method described in FIG. 11 may be performed by the controller 120 of the storage device 100.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device, comprising:
a memory including a first terminal configured to receive commands, a second terminal configured to receive or output data, and a plurality of memory units configured to store data; and
a controller configured to transmit a read command for target data including a plurality of sub-data units to the first terminal, transmit, to the first terminal, a start command instructing initiation of an operation to output one or more of the plurality of sub-data units to the second terminal, and transmit, to the first terminal, a first data output command instructing output of a first sub-data unit among the plurality of sub-data units to the second terminal.

2. The storage device of claim 1, wherein the controller compares first address information corresponding to the first sub-data unit and second address information corresponding to a second sub-data unit before transmitting, to the first terminal, a second data output command instructing output of the second sub-data unit among the plurality of sub-data units to the second terminal.

3. The storage device of claim 2, wherein the first address information indicates an address of a memory unit storing the first sub-data unit, and the second address information indicates an address of a memory unit storing the second sub-data unit.

4. The storage device of claim 2, wherein the controller transmits, to the first terminal, a termination command instructing termination of the operation to output one or more of the plurality of sub-data units to the second terminal, before transmitting the second data output command, when the first address information differs from the second address information, and transmits the second data output command to the first terminal before transmitting the termination command, when the first address information is identical to the second address information.

5. The storage device of claim 4, wherein the controller additionally transmits the start command to the first terminal before transmitting the second data output command to the first terminal, when the termination command is transmitted to the first terminal prior to the second data output command.

6. The storage device of claim 1, wherein the start command instructs activation of one or more memory units among the plurality of memory units.

7. The storage device of claim 6, wherein the termination command deactivates the one or more memory units activated by the start command.

8. A method for operating a storage device comprising a memory with a first terminal for receiving commands, a second terminal for receiving or outputting data, and a plurality of memory units for storing data, the method comprising:
transmitting a read command for target data including a plurality of sub-data units to the first terminal;
transmitting, to the first terminal, a start command instructing initiation of an operation to output one or more of the plurality of sub-data units to the second terminal; and
transmitting, to the first terminal, a first data output command instructing output of a first sub-data unit among the plurality of sub-data units to the second terminal.

9. The method of claim 8, further comprising comparing first address information corresponding to the first sub-data unit and second address information corresponding to a second sub-data unit before transmitting, to the first terminal, a second data output command instructing output of the second sub-data unit among the plurality of sub-data units to the second terminal.

10. The method of claim 9, wherein the first address information indicates an address of a memory unit storing the first sub-data unit, and the second address information indicates an address of a memory unit storing the second sub-data unit.

11. The method of claim 9, further comprising:
transmitting, to the first terminal, a termination command instructing termination of the operation to output one or more of the plurality of sub-data units to the second terminal, before transmitting the second data output command, when the first address information differs from the second address information; and
transmitting the second data output command to the first terminal before transmitting the termination command, when the first address information is identical to the second address information.

12. The method of claim 11, further comprising additionally transmitting the start command to the first terminal before transmitting the second data output command to the first terminal, when the termination command is transmitted to the first terminal prior to the second data output command.

13. The method of claim 8, wherein the start command instructs activation of one or more memory units among the plurality of memory units.

14. The method of claim 13, wherein the termination command deactivates the one or more memory units activated by the start command.
